(19) United States
(12) Patent Application Publication
(10) Pub. No.: US 2024/0329923 A1
(43) Pub. Date: Oct. 3, 2024

(54) AGNOSTIC GRAPH REPRESENTATION AND ENCODING IN HUMAN-READABLE FORM

(71) Applicant: International Business Machines Corporation, Armonk, NY (US)

(72) Inventors: Andrew C. M. HICKS, Highland, NY (US); Stephanie Carys SHUM, Wappingers Falls, NY (US); Anthony Gennaro MANGIACAPRA, Vestal, NY (US); Marcos ARAQUE FIALLOS, Elmwood Park, IL (US); Daniel Nicolas GISOLFI, Hopewell Junction, NY (US)

(21) Appl. No.: 18/192,894

(22) Filed: Mar. 30, 2023

(51) Int. Cl. G06F 5/01; G06F 18/2323

(52) U.S. Cl. CPC G06F 5/01; G06F 18/2323

(57) ABSTRACT

A method for encoding 2D numerical data comprises determining encoding parameters for a received set of 2D numerical data and generating a set of encoded data from the set of 2D numerical data according to the encoding parameters. The encoding parameters indicate a transitional relationship among a plurality of consecutive data points and a unitization interval for sampling the first set of 2D numerical data. When generating the set of encoded data, the encoding method sets a starting point, samples the set of 2D numerical data according to the unitization interval, and determines a string as a value of each data point of the set of the encoded data. The string indicates a position of a present encoded data point in the set of the encoded data, the transitional relationship, and a difference of magnitude between a present encoded data point and an immediately preceding one.

### BACKGROUND

The present invention relates to a data encoding system, method, and computer program product for encoding numerical data, and more specifically relates to encoding 2D numerical data in an agnostic format and a human-readable form.

Numerical data represents a significant type of data for statistical analysis and research purposes. Generally speaking, each data point of a numerical dataset typically represents values at a particular moment. Thus, such a data point alone cannot show any correlation among adjacent data points. Scientists and researchers often use visualization methods to reveal trends of these numerical data. For example, numerical data may be placed on a 2D graph such that major characteristics of these data can be revealed and compared. Although people are good at evaluating visual graphs and can quickly compare one graph to another, such a task is not as easy for a machine to complete. Especially, when there are thousands of graphs to evaluate, this task of visualization and comparison becomes even more difficult for both people and machines. Moreover, the numerical data of a visual graph typically has hundreds or thousands of data points and takes large amounts of space to store and a long time to process.

### SUMMARY

According to one embodiment of the present application, a method for encoding 2D numerical data comprises receiving a first set of 2D numerical data, determining encoding parameters for the set of 2D numerical data, wherein determining the encoding parameters includes determining a first parameter based on a transitional relationship among a plurality of consecutive data points of the set of 2D numerical data, and determining a unitization interval for sampling the first set of 2D numerical data; and generating a set of encoded data from the first set of 2D numerical data according to the encoding parameters. When the encoding method generates the set of encoded data, it further includes setting a starting point for the set of encoded data, sampling the first set of 2D numerical data according to the unitization interval, and determining a string as a value of each data point of the set of the encoded data. The string includes a first symbol determined according to a position of a present encoded data point in the set of the encoded data, a second symbol determined according to the transitional relationship, and a third symbol determined according to a difference of magnitude between a present encoded data point and an immediately preceding one.

According to another embodiment of the present application, a computer program product stores the method for encoding 2D numerical data.

According to another embodiment of the present application, a system comprises a processor and a memory that includes a computer program product to perform the method for encoding 2D numerical data.

### BRIEF DESCRIPTION OF THE DRAWINGS

FIG. 1 shows certain components and systems of a computing environment 100 according to an embodiment of the present application.

FIG. 2 shows a block diagram of an encoding system 200 according to an embodiment of the present application.

FIG. 3 shows a flow chart of an encoding method 300 according to an embodiment of the present application.

FIG. 4a shows a 2D graph 430 formed by a set of original data 410 according to an embodiment of the present application.

FIG. 4b shows an encoding process that translates the numerical data 410 to encoded data 420 according to an embodiment of the present application.

FIG. 5 shows trending features of three sets of encoded data 510, 520, and 530 according to an embodiment of the present application.

FIG. 6 shows a 2D graph of complex shapes formed by a set of numerical data according to an embodiment of the present application.

### DETAILED DESCRIPTION

Given the inefficiency and high costs associated with visualizing and comparing numerical data, there exists a need to translate original numerical data into a form that will take less amount of space to store, allow a user to understand the data more intuitively, and allow a more efficient visualization and comparison of the data by a computer. The present application discloses an encoding method that is capable of capturing major features of a large set of numerical data by intelligently selecting a subset of data points from the original dataset. The encoding method analyzes the numerical data and identifies consecutive data points sharing a similar trend. By including representative nodes in each data cluster, the encoding method is capable of reducing the size of an original set of numerical data while including adequate data to preserve major trends.

Moreover, the encoding method of the present application assigns values of the encoded data such that they are human-readable and indicate transitional relationships among consecutive data points. Strings, rather than numerical values, are used for the encoded data. Their meanings can be easily discerned by a user, which allows the user to understand the data more intuitively and efficiently. As strings are used for the values of the encoded data, algorithms for comparing strings can be used to determine the similarities or differences between two sets of encoded data quantitatively.

The encoding method of the present application further generates metadata for the encoded data and combines the metadata with the encoded data so that another system can use the metadata to read and decode the encoded data, causing the encoded data to be agnostic. The metadata includes basic information about the encoded data, such as origin, graph type, size, and encoded parameters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

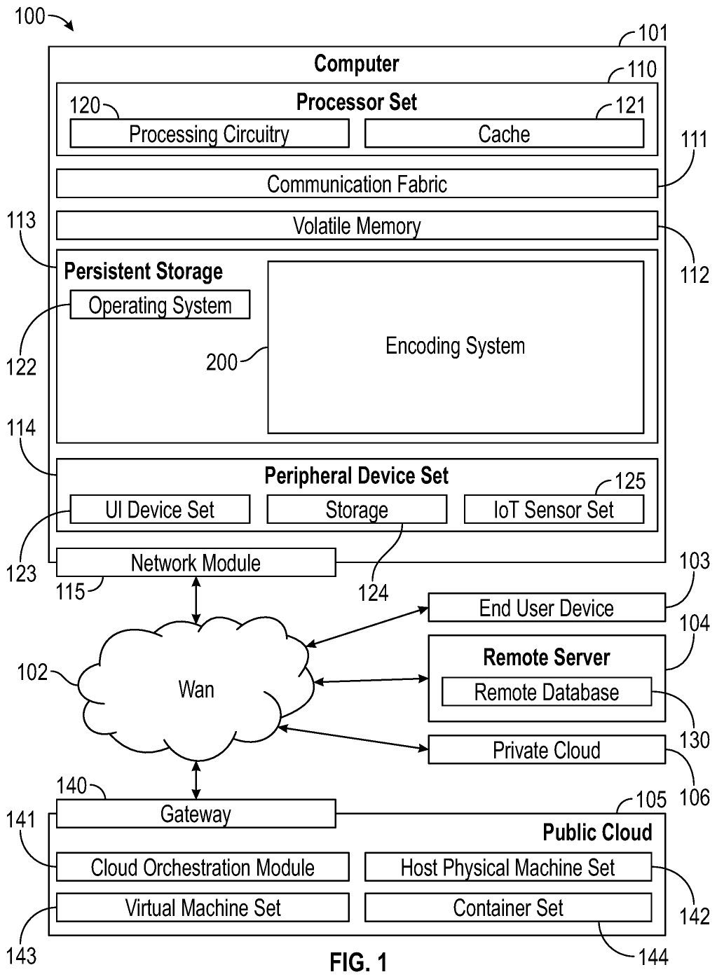

With reference now to FIG. 1, a computing environment 100 contains an example of an environment for the execution of at least some of the computer code involved in performing the inventive encoding methods according to various embodiment of the present application. Block 200 represents an encoding system that implements the inventive encoding methods of the present application in form of an entirely hardware embodiment, an entirely software embodiment (including firmware, resident software, micro-code, etc.) or an embodiment combining software and hardware aspects. Block 200 is configured to store at least part of computer codes designed for implementing the inventive encoding method of the present application and execute these computer codes. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

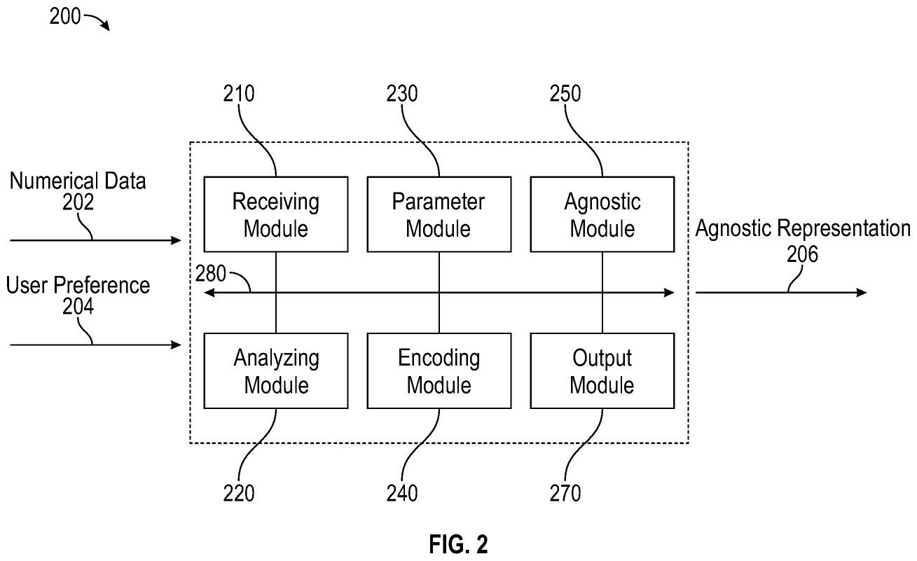

With reference now to FIG. 2, the encoding system 200 includes a receiving module 210, an analyzing module 220, a parameter module 230, an encoding module 240, an agnostic module 250, an output module 270, and a communication network 280. In general, the encoding system 200 encodes received numerical data 202 according to user preferences 204 and pre-determined algorithms and outputs the encoded data in an agnostic representation 206, which is self-contained and can be processed by a plurality of different software and systems. According to an embodiment, the numerical data 202 are 2D numerical data that includes discrete data with fixed numerical values in two dimensions. For example, the 2D numerical data may be time series data that are generated by scientific experiments, numerical simulations, data analysis software, or any other sources. A user may analyze the 2D numerical data by placing them on a 2D coordinate plane to visualize the trend and magnitude. The numerical data 202, in its original form, typically includes very dense data points that can take a long time to process and require a large amount of storage space. However, not all the data points may be included to reveal major trends and magnitudes of the numerical data 202.

According an embodiment of the present application, the agnostic representation 206 includes a fewer number of data points than the original numerical data and can still capture major trending features and critical values of the original numerical data. As a result, the encoded data may require less storage space and less time to process comparing with the original numerical data. Furthermore, the encoded data are both agnostic and human-readable with each data point indicating a transitional relationship among a plurality of the encoded data. According to an embodiment, the encoded data include strings that indicate the magnitude of change between adjacent data points. When commonly recognizable symbols are used for the string of the encoded data, a user can intuitively discern their semantic meanings.

The encoding system 200 also receives user preferences 204 and utilizes the user preferences to encode the original numerical data 202. The user preferences may provide encoding requirements such as a ratio between the size of the encoded data and the original numerical data, encoding granularity or unitization intervals, preferred transitional relationships, and etc. For example, the user may set the ratio between the original numerical data and the encoded data to be 20:1, 10:1, 5:1, or 2:1. When the numerical data is time series data, the user may set a time interval for data points in the encoded data, such as 1 hour, 1 minute, 1 second, or 0.1 second. The user may require the encoding system 200 to use different transitional relationships, such as an absolute change of magnitude, a relative change of magnitude, a straight line, a curve, or a polynomial relationship to segment the original data and encode them accordingly.

The encoding system 200 includes a communication network 280 that is configured to transmit data among the internal functional modules 210-270 or with external modules or systems. The receiving module 210 may be any communication interface capable of receiving the original numerical data 202 and the user preferences 204. The analyzing module 220 is configured to analyze the original numerical data 202 to determine major features of the data, such as peaks and valleys, linear segments, or segments with more complex shapes. The parameter module 230 determines proper encoding parameters for the numerical data 202 according to user preferences 204 and the output of the analyzing module 220. Once the encoding parameters are determined, the encoding module 240 encodes the numerical data and outputs the encoded data to the agnostic module 250. The agnostic module 250 generates metadata for the encoded data. The metadata includes the encoding parameters and other data output by the analyzing module 220. The agnostic module 250 can also combine the metadata and the encoded data in a single file. Other computer systems or software may first read the metadata from the file and then read and decode the encoded data according to the metadata. In this way, the file can be read by many different systems and become agnostic to the particular computer system. The output module 270 may determine whether an optimization of the agnostic representation 206 is required or not. If an optimization is required, the output module sends a message to the analyzing module 220 to restart the encoding process. Detailed functions and algorithms related to the analyzing module 220, the parameter module 230, the encoding module 240, the agnostic module 250, and the output module 270 will be described in the following sections of this application.

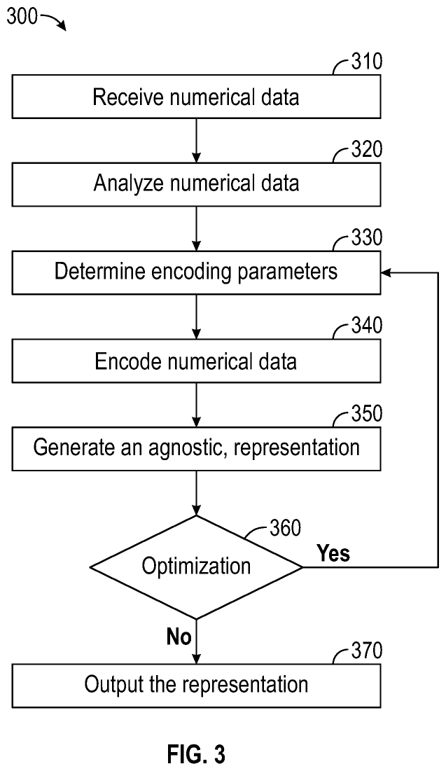

With reference now to FIG. 3, an encoding method 300 for encoding the numerical data according to an embodiment of the present application may include a receiving step 310 for receiving the to-be encoded numerical data from another source, an analyzing step 320 for identifying major features of the numerical data, an determining step 330 for selecting encoding parameters, an encoding step 340 for encoding the numerical data based on the encoding parameters, a generating step 350 for generating an agnostic representation of the numerical data, an optimization step 360 for determining whether the agnostic representation may be further optimized, and an outputting step 370 for outputting the agnostic representation. The encoding system 200 may implement this encoding method 300 in the form of an entirely hardware embodiment, an entirely software embodiment (including firmware, resident software, micro-code, etc.) or an embodiment combining software and hardware aspects.

At the receiving step 310, the receiving module 210 receives numerical data, which may be transmitted from an external source or be retrieved from an internal storage. The numerical data may have been processed by another software or system and have unique formats and data structures that that are native to that software of system and are not agnostic. According to an embodiment, the numerical data represents 2D numerical data that has two dimensions and is suitable for visualization in a 2D coordinate plane in the forms of line graphs, bar graphs, pie charts, histograms, and etc. The receiving step 310 may also receive user preferences related to the numerical data. The user preferences may specify a unitization interval for encoding the numerical data, compression ratios between the encoded data and the numerical data, or preferred transitional relationships for encoding the numerical data, and etc. The unitization interval relates to the level of granularities used to select the numerical data for encoding. When the numerical data represents a time series data, the unitization interval indicates a time scale to sample the numerical data. For example, when the time series data is collected every one second over a period of twenty four hours, a unitization interval may be set to one minute such that one data point per minute will be picked from the time series data and then included in the encoded data.

At the analyzing step 320, the analyzing module 220 analyzes the numerical data to identify major features of the numerical data, such as trends and spikes among the data points. For example, the analyzing step 320 may identify peaks and valleys in the numerical data, and then do a curve fitting for the data cluster between peaks and valleys. A straight line, a circle, a polynomial curve, a trigonometric curve, or any other suitable curves may be used by the analyzing step 320 to fit the data points between adjacent peaks and valleys. According to an embodiment, the analyzing step 320 calculates the change of magnitude between adjacent peaks and valleys.

At the determining step 330, the determining module 230 determines a set of encoding parameters based on the user preferences and the results of the analyzing step 320. The determining step 330 selects a starting point and a suitable unitization interval to encode the data. The determining step 330 may also select a compression ratio between the encoded data and the original numerical data. In one embodiment, the determining step 330 selects encoding parameters to ensure that the encoded data can capture the major features of the numerical data. According to an embodiment, when plural sets of numerical data are encoded collectively, the determining step 330 determines a common alignment point used to align the plural sets of numerical data to a common starting point in one dimension. The determining step 330 may also determine a common unitization interval for the plural sets of numerical data in the same dimension. With the common alignment point and the common unitization interval, the plural sets of numerical data can be normalized in that dimension and be comparable.

At the encoding step 350, the encoding module 250 encodes the numerical data according to the encoding parameters. According to an embodiment, the encoding module 250 selects data points according to the unitization interval determined by the determining step. The unitization interval may be constant for the entire set of numerical data or be variable depending on the transitional relationship of a data cluster. The encoding module 250 further determines values for each selected data points. According to an embodiment, the encoding module 250 uses strings as values for each data point in the encoded data such that a human user may discern the trends of encoded data without the need to plot the encoded data on a graph. The string of each data point includes a plurality of symbols, where at least one symbol indicates the position of that data point in a first dimension, at least one symbol indicates a transitional relationship among adjacent data points, and at least one symbol indicates a qualitative value, such as a change of magnitude, for the transitional relationship.

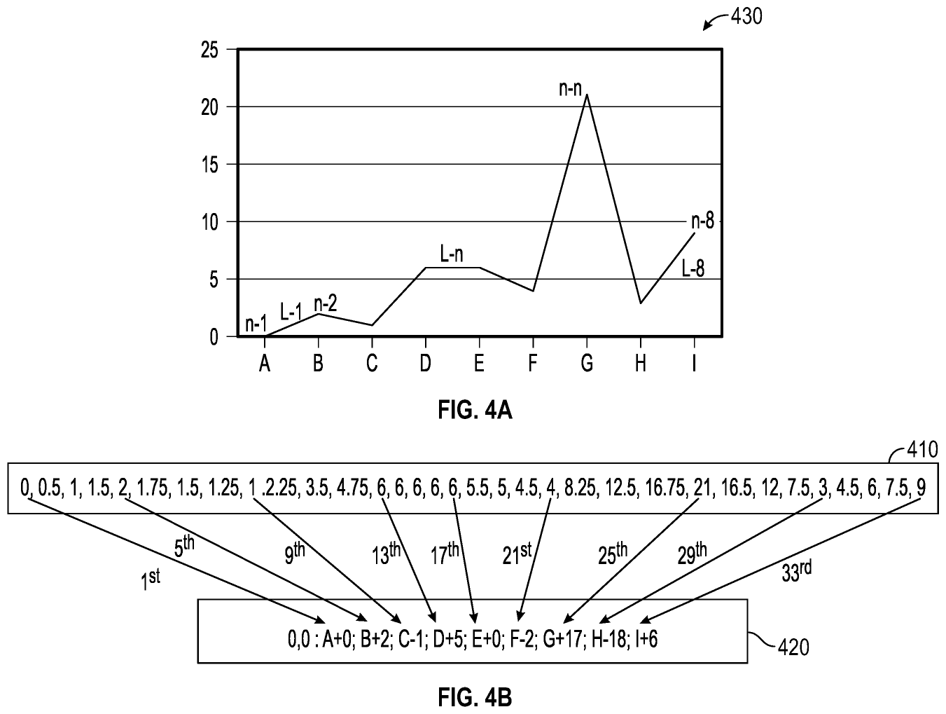

With now reference to FIGS. 4a and 4b, an example of encoding numerical data has been illustrated. FIG. 4a shows a 2D graph 430 based on a set of time series data whose values are shown as numerical data 410 in FIG. 4b. In FIG. 4a, the horizontal axis represents the time line, while the vertical axis represents the values obtained for a particular moment. The numerical data 410 has 33 data points. Once they are placed on the 2D coordinate plane, it can be seen that the data 410 forms a plurality of peaks and valleys (n-1, n-2, . . . , n-8) connected by straight lines. The plurality of line segments (L-1, . . . L-n, . . . , L-8) show trends such as increasing, plateauing, or decreasing among adjacent peaks or valleys. The analyzing step 320 identifies and extracts the peaks and valleys and the transitional relationships of the numerical data 410. The graph 430 certainly suggests that this set of numerical data 410 may be substantially represented by only a subset of the original numerical data, such as those peaks and valleys. Other data may be discarded because they do not contribute additional substantive features to the numerical data 410. The inventive encoding method of the present invention is conceived to generate that subset of data by encoding the original data 410.

With now reference to FIG. 4b, the encoding method translates the set of numerical data 410 to a set of encoded data 420 according to an embodiment of the present application. First, the encoding module 240 adds a starting point “0,0” to the encoded data 420 and uses A semicolon right behind the starting point to delineate the starting point from the rest. For the string “0,0,” the first symbol “0” suggests the position of the starting point in the encoded data, the punctuation mark “,” means there is no preceding data, and the second symbol “0” means there is no change of magnitude from the preceding point.

Then, the encoding module 250 selects the 1^{st} data point “0” from the numerical data 410 and generates a corresponding data point “A+0” in the encoded data 420, where the symbol “A” indicates the position of the 1^{st} data point, the symbol “+” indicates an increase from the starting point to the 1^{st} data point, and the symbol “0” indicates that the magnitude of the increase is “0.” Unlike conventional methods, any single encoded data point as generated by the inventive encoding method of the present application, by itself, suggests a trend between that data point and the immediately preceding one. This allows a user to understand changes among the numerical data much more efficiently and intuitively.

After encoding the 1^{st} data point of the numerical data 410, the encoding module 250 then selects one in every four data points (a compression ratio of 4) of the numerical data for encoding and generate a string for the encoded data to indicate a change of magnitude from the immediately preceding encoded data point. For example, the encoding module selects the 5^{th} data point of the numerical data for encoding, which has a numerical value of “2.” The encoded data point that is immediately preceding has a value of “0.” Thus, the encoded data of the 5^{th} data point has a string value of “B+2,’ where the symbol “B” indicates the position of the encoded data, the symbol “+” indicates that the value of this data point increases from the immediately preceding data point, and the symbol “2” indicates the magnitude of increase is 2 (The 5^{th} data point has a value of 2 while the 1^{st} data point is 0).

The encoding module 250 continues the encoding process until the end of the numerical data 410. Specifically, the encoding module 250 selects the 9^{th}, 13^{th}, 17^{th}, 21^{st} 25^{th} 29^{th}, and 33^{rd} data points and translates them to “B+2,” “C−1,” “D+5,” “E+0,” “F−2,” “G+17,” “H−18,” and “I+6” in the encoded data 420 of FIG. 4b. A comma “,” is used to delineate each encoded data point. The same algorithm as described with regard to the 5^{th} data point is used to determine the string values for each encoded data point. For example, the position symbol “B,” “C,” . . . “I,” increases by one alphabetic order each time a new encoded data is generated, and each string value includes a symbol indicating the transitional relationship and a symbol indicting the change of magnitude. Using the 29^{th} data point of the numerical data 410 as an example: the encoded data corresponding to the 29^{th} data point is “H−18,” where the letter “H” indicates the position, the subtraction sign “−” indicates a decreasing trend, and the number “18” indicates the magnitude of decrease is 18. This is because the value of 29^{th} data point of the numerical data 410 is 3 and is 18 less than that of the 25^{th} data point, which is 21.

A person of ordinary skill in the art, when guided by the teachings of the present application, would realize that other symbols may be used to indicate the position of the encoded data, the transitional relationship, or the change of magnitude. For example, Greek letters or Latin symbols may be used to indicate the transitional relationship.

After the encoding module 250 completes the encoding process of the numerical data, the agnostic module 260 generates metadata for the encoded data. The metadata includes basic information of the encoded data and may include data indicating the encoded data's origin, the graph type, size, and encoding parameters (time scale, level of granularity, unitization interval, and type of transitional relationships). According to an embodiment, the generation module 260 further combines the metadata and the encoded data to generate a file, where the header of the file is used to store the metadata and the body of the file is used to store the encoded data. Thus, another system can use the header to obtain the basic information of the encoded data and then decode the data without the need to use any specialized software. In this way, the file can be deemed agnostic, which can be decoded by many different systems and software.

At the optimization step 260, it is determined whether the agnostic representation may be further optimized. When an optimization is required, the process goes back to the analyzing step. When an optimization is not required, the process goes to the outputting module 270. According to an embodiment, the optimization step 260 may be implemented by the encoding module 250 or the outputting module 270. According to an embodiment, the optimization step 260 determines whether to optimize the encoded data based on a size of the agnostic representation, a number of major features captured by the encoded data, or the combination thereof.

At the outputting step 370, the outputting module 270 may store the agnostic representation in a storage or transmit it to another system.

According to an embodiment, when multiple sets of numerical data are encoded collectively, the encoding method as set forth in the present application is configured to implement a normalization step when encoding these datasets. When the multiple sets of numerical data are time series data, the datasets will be normalized so that data with varying ranges can be compared. The smallest dataset which has the least number of data points is selected as the reference dataset. Then, a normalization ratio n is determined for each other dataset based on the size between that dataset and the reference dataset.

where n=(size of a present dataset)/(size of the reference dataset)

Once the normalization ratio n is determined, the encoding method will take one data point in every nth data points from the present dataset to create a normalized dataset. According to another embodiment, the normalization ratio may change depending on other parameters of the encoding step. For example, rather than simply using the value of the original data, the user can decide to use statistical methods to determine values of the encoded data, such as the mean of adjacent points and the max/min of adjacent points, or the user can also decide to take the reference dataset and repeat data points to expand it. User preferences 204 are used to include these instructions of a user.

In the case that there is no common divisor between the two sets of numerical data, selection of an interval combining with statistical computation (i.e. mean, max, min) to compute a representative point for that interval may also be implemented such that the timelines in two datasets can match up.

According to another embodiment, when encoding a range of data points where the trend follows a consecutive pattern for 2 or more data points, the encoding method can further condense this range of data points by marking the beginning and ending points of the trend and denoting the change that occurs between each point in the series. For example, a string value, “A−F+2,” indicate that points A and F are the beginning and ending points of a consistent trend where the rate of change is 2.

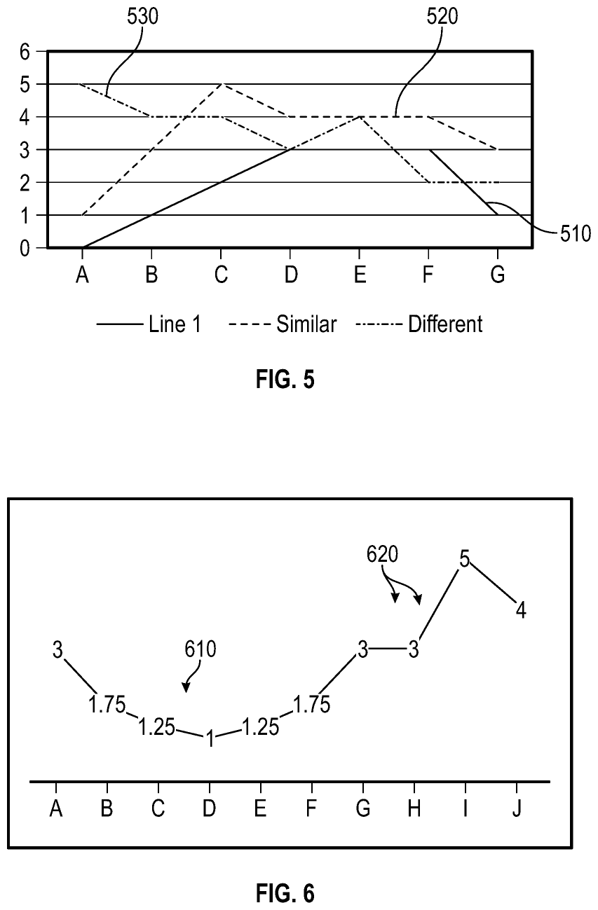

With now reference to FIG. 5, similarities among three sets of encoded numerical data 510, 520, and 530 are determined. As shown in FIG. 5, the three sets of encoded numerical data are line graphs, each of which is formed by a plurality of line segments. Values of the three sets of encoded data are shown below, where each data point shows the increase of magnitude between a present data point and the immediately preceding one:
Encoded numerical data 510: 0,0: A+0; B+1; C+1; D+1; E+0; F+0; G−2.
Encoded numerical data 520: 0,0: A+0; B+2; C+2; D−1; E+0; F+0; G−1.
Encoded numerical data 530: 0,5: A+0; B−1; C+0; D−1; E+1; F−1; G+0.

The set of encoded data 510 is used as the reference data, and whether the numerical data 520 and 530 are similar with the numerical data 510 is determined. In a conventional method, the line graphs corresponding to the data sets 510, 520, and 530 will be plotted, and then a user may observe the graphs and make a determination. Here, the term “similar” or “similarity” means how closely the trends of the two sets of data points generally follow each other. By looking at the graphs in FIG. 5, a user may determine that the numerical data 520 is similar with the numerical data 510 while the numerical data 530 is different from the numerical data 510, but without any quantitative evaluation. This conventional method is inherently inefficient and subjective.

According to an embodiment of the present application, the encoded numerical data allows a more efficient and objective determination as to similarities among different sets of encoded data. As values of data points of the encoded data are strings, many well-established algorithms in information theory, linguistics, and computer science can be used to calculate difference between these strings. For example, Levenshtein distance or edit distances can be used to indicate whether different sets of encoded numerical data are similar or not. To achieve this, a weight related to rate of change may be assigned to the replacement operation of Levenshtein distance. For example, a replacement operation may assign a weight that equals to the absolute value of the differences between the two data points that use straight line as the transitional relationship. Thus, the replacement operation of Levenshtein distance can indicate how divergent two line segments in different sets of numerical data are. For the numerical data 510, 520, and 530, the cumulative weight of replacement operation indicates the cumulative divergence between these sets of data. The following table shows the cumulative weight of replacement operations between the numerical data 510 and 520, where the first row is the numerical data 510, the first column is the numerical data 520, and the diagonal line is the cumulative weight of the replacement operation according to Levenshtein distance.

| | A + 0 | B + 1 | C + 1 | D + 1 | E + 0 | F + 0 | G − 2 |
|---|---|---|---|---|---|---|---|
| A + 0 | 0 | | | | | | |
| B + 2 | | 1 | | | | | |
| C + 2 | | | 2 | | | | |
| D − 1 | | | | 4 | | | |
| E + 0 | | | | | 4 | | |
| F + 0 | | | | | | 4 | |
| G − 1 | | | | | | | 5 |

When the same Levenshtein distance is calculated for the numerical data 510 and the numerical data 530, the cumulative weight of replacement operations is 9. Thus, the analysis shows the numerical data 520, which has an accumulative weight of 5, follows the trend of the numerical data 510 more closely than the numerical data 530, which has an accumulative weight of 9.

With now reference to FIG. 6, a set of numerical data 600 having complex curves may also be encoded according to an embodiment of the present application. Values of this set of numerical data 600 are (3, 1.75, 1.25, 1, 1.25, 1.75, 3, 3, 5, 4) as shown in FIG. 6. After the numerical data 600 is placed on a 2D graph, it shows a first cluster of data points 610 and a second cluster of data points 620. The first cluster of data points 610 represents a general circular shape, while the second cluster of data points 620 represents a plurality of linear segments. In one embodiment, the encoding method may simply use straight lines to encode the entire set of numerical data 600. To encode the first cluster of data points 610, the analyzing module may first use a proper unitization interval to approximate the curve by line segments and identify the nodes corresponding to each line. The encoding module then encodes the entire set of data by using the straight line as the transitional relationship among adjacent data points.

In another embodiment, the encoding method may encode the first cluster 610 and the second cluster 620 with different transitional relationships. For example, the first cluster 610 is encoded by using a curve as the transitional relationship while the second cluster 620 is encoded by using a straight line. To encode the numerical data according to this method, the analyzing module will first identify the demarcation data point between the first cluster 610 and the second cluster 620 and then identify major features of the first cluster and the second cluster. Then, the encoding module encodes the numerical data 600 according to the results of the analyzing module. An example of the encoded data according this embodiment may be “(A3, D1, G3); H+0; I+2; J−1,” where “(A3, D1, G3)” is used to code the first cluster of data 610, and “H+0; I+2; J−1” are used to code the second cluster of data 620.

According to an embodiment of the present invention, the encoding method generates a string based representation of graphs and prioritizes efficiency and readability of encoded data. Rather than storing the original data points in their entirety, offsets from point to point may be used to encode the original data points. Furthermore, trends are taken into account to represent a section of the graph, thus reducing the number of points necessary to provide a relatively faithful representation of the original data points. When the numerical data is 2 dimensional, the resulted encoded data can be a simple 1D string data. In addition to a reduction in the size of the original data, the format of the encoded data reduces the burden of computing the similarity between several graphs. As an example, a modified version of edit distance formulas like Levenshtein's, which is commonly used to compare similarities or differences among string data, can be used to compute similarity between graphs. Other advantages of this representation lie in the generic format that can express charts of varying type and scale in a readable manner that can be used in conjunction with graphing libraries, agnostic of programming language or visualization engine. Finally, it allows the use of NLP, statistical data mining, and graph manipulation via preexisting text analysis tooling.

According to some embodiment of the present application, the encoding method utilizes a transition-based encoding between points to represent an existing visual graph, and utilizes piecewise graph encoding to approximate slope, curvature, arc length, polynomials, asymptotes, and periodic functions. Certain advantages of the present encoding method include dynamic highlighting of parallel and divergent areas of multiple datasets, automatic scaling of timelines due to a linear encoding structure, and condensing consecutive similar data points into segments to represent the original trend.

While the foregoing is directed to embodiments of the present invention, other and further embodiments of the invention may be devised without departing from the basic scope thereof, and the scope thereof is determined by the claims that follow.

What is claimed is:

1. A method for encoding 2D numerical data, the method comprising:
receiving a first set of 2D numerical data;
determining encoding parameters for the first set of 2D numerical data, wherein determining the encoding parameters includes:
determining a first parameter based on a transitional relationship among a plurality of consecutive data points of the first set of 2D numerical data, and
determining a unitization interval for sampling the first set of 2D numerical data; and
generating a set of encoded data from the first set of 2D numerical data according to the encoding parameters, wherein generating the set of encoded data includes:
setting a starting point for the set of encoded data;
sampling the first set of 2D numerical data according to the unitization interval; and
determining a string as a value of each data point of the set of the encoded data, wherein the string includes:
a first symbol determined according to a position of a present encoded data point in the set of the encoded data;
a second symbol determined according to the transitional relationship; and
a third symbol determined according to a difference of magnitude between a present encoded data point and an immediately preceding one.

2. The method of claim 1, further comprising:
identifying peaks and valleys in the first set of 2D numerical data;
separating the first set of 2D numerical data into a plurality of data clusters according to the peaks and valleys, a data cluster being formed by consecutive data points; and
identifying the transitional relationship for each data cluster.

3. The method of claim 2, further comprising:
receiving user preferences for encoding the first set of 2D numerical data; and
determining the encoding parameters according to the user preferences, identified peaks and valleys, and identified transitional relationship of each data cluster.

4. The method of claim 1, further comprising:
receiving a second set of 2D numerical data having a fewer number of data points than the first set of 2D numerical data;
calculating a normalization ratio corresponding to a ratio between the number of data points in the first set of 2D numerical data and the second set; and
normalizing the first set and second set of 2D numerical data by sampling the first set of 2D numerical data according to the normalization ratio.

5. The method of claim 1, further comprising:
generating metadata for the set of the encoded data; and
combining the metadata and the set of the encoded data into a file, wherein the metadata includes the encoding parameters.

6. The method of claim 5, wherein the metadata further includes information indicating a graph type of the set of the encoded data.

7. The method of claim 1, further comprising:
when a data cluster of the first set of 2D numerical data demonstrates a shape with a curvature, approximating the shape by a plurality of line segments and setting straight lines as the transitional relationship for the data cluster.

8. A system, comprising:
a processor; and
a memory, wherein the memory includes a computer program product to perform operations for encoding 2D numerical data, the operations comprising:
receiving a first set of 2D numerical data;
determining encoding parameters for the first set of 2D numerical data, wherein determining the encoding parameters includes:
determining a first parameter based on a transitional relationship among a plurality of consecutive data points of the first set of 2D numerical data, and
determining a unitization interval for sampling the first set of 2D numerical data; and
generating a set of encoded data from the first set of 2D numerical data according to the encoding parameters, wherein generating the set of encoded data includes:
setting a starting point for the set of encoded data;
sampling the first set of 2D numerical data according to the unitization interval; and
determining a string as a value of each data point of the set of the encoded data, wherein the string includes:
a first symbol determined according to a position of a present encoded data point in the set of the encoded data;
a second symbol determined according to the transitional relationship; and
a third symbol determined according to a difference of magnitude between a present encoded data point and an immediately preceding one.

9. The system of claim 8, wherein the operations further comprise:
identifying peaks and valleys in the first set of 2D numerical data;
separating the first set of 2D numerical data into a plurality of data clusters according to the peaks and valleys, a data cluster being formed by consecutive data points; and
identifying the transitional relationship for each data cluster.

10. The system of claim 9, wherein the operations further comprise:
receiving user preferences for encoding the first set of 2D numerical data; and
determining the encoding parameters according to the user preferences, identified peaks and valleys, and identified transitional relationship of each data cluster.

11. The system of claim 8, wherein the operations further comprise:
receiving a second set of 2D numerical data having a fewer number of data points than the first set of 2D numerical data;
calculating a normalization ratio corresponding to a ratio between the number of data points in the first set of 2D numerical data and the second set; and
normalizing the first set and second set of 2D numerical data by sampling the first set of 2D numerical data according to the normalization ratio.

12. The system of claim 8, wherein the operations further comprise:
generating metadata for the set of the encoded data; and
combining the metadata and the set of the encoded data into a file, wherein the metadata includes the encoding parameters.

13. The system of claim 12, wherein the metadata further includes information indicating a graph type of the set of the encoded data.

14. The system of claim 8, wherein the operations further comprise:
when a data cluster of the first set of 2D numerical data demonstrates a shape with a curvature, approximating the shape by a plurality of line segments and setting straight lines as the transitional relationship for the data cluster.

15. A computer program product for encoding 2D numerical data, the computer program product comprising:
a computer-readable storage medium having computer-readable program code embodied therewith, the computer-readable program code executable by one or more computer processors to:
receive a first set of 2D numerical data;
determine encoding parameters for the first set of 2D numerical data, wherein determining the encoding parameters includes determining a first parameter based on a transitional relationship among a plurality of consecutive data points of the first set of 2D numerical data, and determining a unitization interval for sampling the first set of 2D numerical data; and
generate a set of encoded data from the first set of 2D numerical data according to the encoding parameters, wherein generating the set of encoded data includes:
setting a starting point for the set of encoded data;
sampling the first set of 2D numerical data according to the unitization interval; and
determining a string as a value of each data point of the set of the encoded data, wherein the string includes:
a first symbol determined according to a position of a present encoded data point in the set of the encoded data;
a second symbol determined according to the transitional relationship; and
a third symbol determined according to a difference of magnitude between a present encoded data point and an immediately preceding one.

16. The computer program product of claim 15, wherein the computer-readable program code is further executable to:
identify peaks and valleys in the first set of 2D numerical data;
separate the first set of 2D numerical data into a plurality of data clusters according to the peaks and valleys, a data cluster being formed by consecutive data points; and
identify the transitional relationship for each data cluster.

17. The computer program product of claim 16, wherein the computer-readable program code is further executable to:
receive user preferences for encoding the first set of 2D numerical data; and
determine the encoding parameters according to the user preferences, identified peaks and valleys, and identified transitional relationship of each data cluster.

18. The computer program product of claim 15, wherein the computer-readable program code is further executable to:
receive a second set of 2D numerical data having a fewer number of data points than the first set of 2D numerical data;
calculate a normalization ratio corresponding to a ratio between the number of data points in the first set of 2D numerical data and the second set; and
normalize the first set and second set of 2D numerical data by sampling the first set of 2D numerical data according to the normalization ratio.

19. The computer program product of claim 15, wherein the computer-readable program code is further executable to:
generate metadata for the set of the encoded data; and
combines the metadata and the set of the encoded data into a file, wherein the metadata includes the encoding parameters.

20. The computer program product of claim 15, wherein the computer-readable program code is further executable to:
when a data cluster of the first set of 2D numerical data demonstrates a shape with a curvature, approximate the shape by a plurality of line segments and set straight lines as the transitional relationship for the data cluster.
